(19) United States
(12) Patent Application Publication
(10) Pub. No.: US 2011/0047605 A1
(43) Pub. Date: Feb. 24, 2011

(54) System And Method For Authenticating A User To A Computer System

(75) Inventors: James L. Sontag, Portland, OR (US); Scott A. Blomquist, Portland, OR (US)

Correspondence Address: TOMLINSON & O'CONNELL, P.C., TWO LEADERSHIP SQUARE, 211 NORTH ROBINSON, SUITE 450, OKLAHOMA CITY, OK, 73102, US

(73) Assignee: Vidoop, LLC, Portland, OR (US)

(21) Appl. No.: 12/526,072

(22) PCT Filed: Feb. 6, 2008
(86) PCT No.: PCT/US08/53129

§ 371 Date: Nov. 8, 2010

Related U.S. Application Data
(60) Provisional application No. 60/888,341, filed on Feb. 6, 2007.

(51) Int. Cl. H04L 9/32; G06F 17/00; G06F 7/04

(52) U.S. Cl. 726/7

(57) ABSTRACT

A system and method for verifying the identity of a user to a secure website. The user provides a server associated with the secure website with an account identifier, a biometric authentication element comprising a voice print and secret pass phrase, and contact information for a user communication device during the enrollment process. Upon subsequent attempts to access the secure website the user is prompted to provide an account identifier. Upon receipt of the account identifier, the server transmits a request for voice print and pass phrase samples to the user's communication device. The server receives the samples, compares them to the user's stored voice print and pass phrase and authenticates the user to the secure website if the sample voice print and sample pass phrase match the stored voice print and pass phrase sample. The server request may comprise a sponsored message. Additionally, the server may request the user speak a pass phrase comprising an advertiser's slogan, product name, or company name.

### CROSS-REFERENCE TO RELATED APPLICATIONS

The present application claims the benefit of U.S. Provisional Application No. 60/888,341 filed on Feb. 6, 2007, the contents of which are incorporated herein fully by reference.

### FIELD OF THE INVENTION

The present invention relates generally to the authentication and verification of the identity of a computer system user and more particularly to authentication of users based upon biometric authentication parameters.

### BACKGROUND OF THE INVENTION

Secure access to computer systems and computer networks has been traditionally guarded by a username and password pair assigned on a per user basis. This requires the user to guard against disclosure or theft of the username and password from unauthorized users. If the username and password are not protected; accounts and files can be compromised. Several methods and tools have been developed to fraudulently obtain usernames and passwords. Thus, companies and individuals have employed elaborate and costly additional security methods and tools in an attempt to curtail unauthorized access to accounts and files. Such systems include Sitekey™, digital certificates, cookies, and tokens. Many of these systems and methods have been found ineffective or incapable of thwarting fraudulent access attempts. Therefore, there remains a need for improved systems and methods for protecting information accessible from remote locations via a computer network.

### SUMMARY OF THE INVENTION

The present invention is directed to a method to verify an identity of a computer system user. Wherein the computer system is adapted to store an account identifier. The method comprises storing a voice authentication element associated with the account identifier. The voice authentication element comprises an account specific voice print and an account specific pass phrase. The account identifier is received when an attempt to access the computer system from a first input device occurs. A communication link is established between the computer system and a second input device and a voice input sample is requested using the second input device. The voice input sample is received from the second input device. The voice input sample communicates a voice print sample and a pass phrase sample. The user is authenticated when the voice print sample substantially matches the account specific voice print associated with the account identifier attempting to access the computer system and when the pass phrase sample substantially matches the account specific pass phrase.

The present invention is further directed to a system for verifying the identity of a user to a computer system. The system comprises a memory storage device, a first input channel, a first output channel, a second input channel, and a processing unit. The memory storage device is adapted to store an account identifier and an authentication element associated with the account identifier. The authentication element comprises an account specific voice print and an account specific pass phrase. The first input channel is adapted to receive the account identifier from a first input device. The first output channel is adapted to transmit a request for an authentication element sample. The second input channel receives the authentication element sample from a second user input device. The authentication element sample comprises a voice print sample and a pass phrase sample. The processing unit compares the voice print sample and pass phrase sample to the account specific voice print and the account specific pass phrase of the authentication element associated with the account identifier.

Further still, the invention is directed to a method for authenticating the identity of a website user. The method comprises providing a memory storage device for storing information including a stored voice print and an account identifier for each of a plurality of website users having access to a secure website. The stored voice print comprises a user specific pass phrase. At least one account identifier is received from a computer system access device. A communication link is established with a voice communication device associated with the account identifier after receiving the account identifier. A voice print sample comprising a pass phrase sample is collected from the voice communication device. The stored voice print is compared to the voice print sample and the pass phrase sample is compared with the user specific pass phrase. The website user is authenticated when both the stored voice print substantially matches the voice print sample and the pass phrase sample substantially matches the user specific pass phrase.

The present invention is further directed to a system for authorizing a user to a secure website. The system comprises a memory unit for storing an account specific voice print comprising a unique pass phrase, an account identifier, and a voice communication device contact. The system further comprises a means for receiving the account identifier from the user and a means for establishing a communication link with a voice communication device using the voice communication device contact to receive a voice print sample comprising a pass phrase sample from the user. Further, the system comprises a processing means for comparing the sample voice print to the stored voice print associated with the user and for allowing access to the secure website when the stored voice print and the sample voice print are substantially identical.

Further still, the invention is directed to a system for verifying the identity of a user to a secure website server. The system comprises a memory storage device, a first user input, a second user input, and a communications module. The memory storage device is adapted to store authentication information related to a plurality of user accounts. The authentication information comprises an account identifier and a stored biometric authentication element. Each account identifier and stored biometric authentication element set is unique to an individual user. The first user input device is adapted to query the secure website server for access to at least one of the user accounts and to transmit at least one account identifier to the secure website server. The second user input device is adapted to transmit a biometric authentication sample. The communications module establishes a communication channel between the second user input device and an authentication server. The authentication server is adapted to verify the identity of the user and allow access to the secure website when the biometric authentication sample and the stored biometric authentication element associated with the account identifier are substantially similar.

### BRIEF DESCRIPTION OF THE FIGURES

FIG. 1 is a block diagram that illustrates an overview of the system of the present invention. The system disclosed uses a biometric authentication element to grant or deny access to a secure computer system.

FIG. 2 is a flowchart illustrating a high-level overview of a method of the present invention.

### DESCRIPTION OF THE PRESENT INVENTION

Many popular websites and web-based databases require user authentication before allowing a user to utilize the site's full functionality. For example, many financial institutions allow account holders to conduct financial transactions such as the payment of bills and transfer of funds via the Internet. As consumers have become increasingly comfortable with online transactions, the popularity and functionality of online banking websites has increased dramatically. The increase in popularity of online financial transactions has also given rise to an increase in the theft of account holder identity and fraudulent transactions. As discussed above, many systems and methods have been developed in an attempt to combat the rise in identity theft and fraudulent transactions. However, there remains a need for systems and methods of user authentication that unequivocally assure the identity of the individual attempting to access the computer system storing the user's personal and confidential information. Accordingly, the present invention is directed to methods and systems designed to incorporate a biometric authentication element into the authentication process without causing undue delay or discomfort to the user. One skilled in the art will appreciate that the method of authentication described herein may be used in conjunction with the graphical user interface described in U.S. patent application Ser. No. 29/276,601 filed Jan. 30, 2007, entitled “Graphical User Interface” and the authentication methods described in U.S. patent application Ser. No. 11/420,061 filed May 24, 2006, entitled “Graphical Image Authentication and Security System” both of which are incorporated herein by reference.

While the present invention is described with reference to a biometric authentication element comprising the user's voice print, it will be appreciated that the application is not limited to the use of a voice print. Rather, other biometric indices such as fingerprints, retinal imprints, and DNA may be used to authenticate a user to a computer network in accordance with the present invention. Such alternative methods may require the use of additional biometric sample collection device 28 capable of reading the desired biometric component.

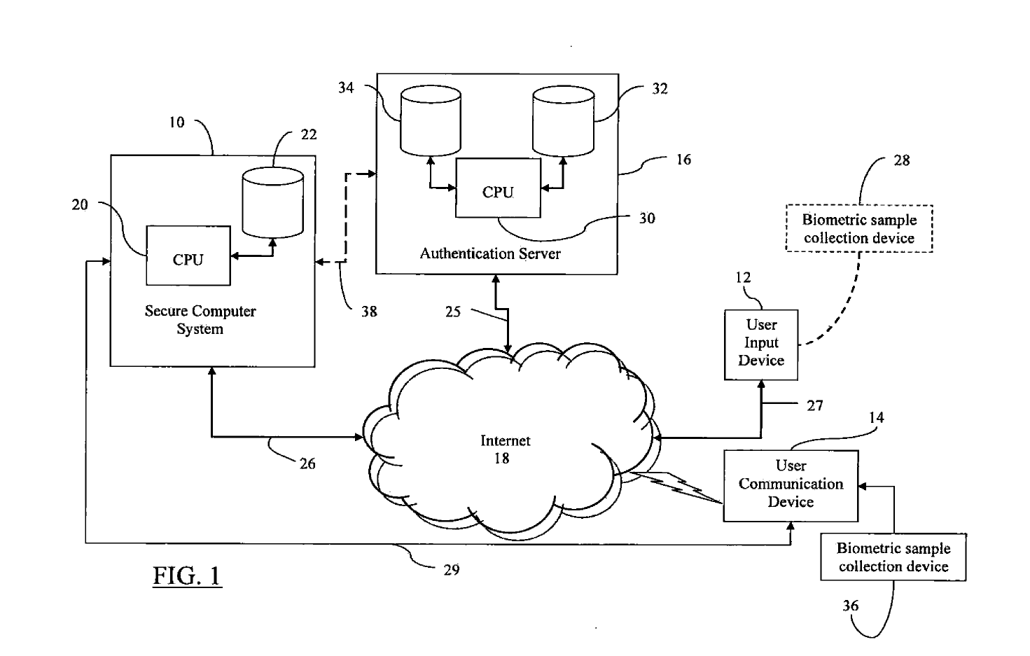

Turning now to FIG. 1 there is shown therein a system for verifying the identity of a user to a computer system 10. The system of FIG. 1 comprises a secure computer system 10, a computer system access device comprising a user input device 12, a user communication device 14 and an optional authentication server 16. Each component of the system of FIG. 1 may communicate with the other as discussed herein via a connection (25, 26, 27) to the Internet 18.

The term secure computer system 10, as used herein, may mean any computer network accessed via the Internet 18 or otherwise comprising a user identity authentication requirement. The secure computer system 10 may comprises a memory storage device 22 for storing an account identifier and an authentication element associated with the account identifier. The secure computer system 10 may further comprise a processing unit 20 for comparing a voice print sample and pass phrase collected from the user communication device 14 to an account specific voice print and account specific pass phrase both associated with the account identifier. One skilled in the art will appreciate the secure computer system 10 may comprise a website server, a wide area network, local area network, or a secure network having access points such as automated teller machines and credit or debit card scanners. One skilled in the art will also appreciate the authentication element stored at the computer system 10 may comprise an account identifier, a stored biometric authentication element, and an account specific pass phrase. As used herein, the term “biometric authentication element” may include a user specific voice print, retinal imprint, fingerprint, or DNA sequence stored at the memory storage device (22, 32, 34). For purposes of illustration only, the present invention will be discussed with reference to the use of a biometric authentication element comprising a user specific voice print.

The term “account specific pass phrase” may comprise at least a secret single word selected by the user during the account enrollment process and spoken by the user during an authentication session. In accordance with the present invention, the account specific pass phrase may comprise either user selected password or a third-party sponsored phrase generated by the secure computer system 10.

To add an additional layer of security to the authentication system of the present invention the authentication element may further comprise a user selected password transmitted input by the user from either the user input device 12 or the user communication device 14. Alternatively, the processor 20, 30 may be programmed to generate a randomly selected verification code transmitted to either the user input device 12 or the user communication device 14 via a first output channel 25, 26 and the Internet 18 or a land-based telephone line 29. The randomly selected verification code may be associated with the user account identifier received from the first user input device 12 for a single authentication session. The randomly selected verification code may comprise at least one alphanumeric character.

Continuing with FIG. 1, the user input device 12 may comprise any device adapted to receive input from a user to communicate with the secure computer system 10. Such user input device 12 may comprise a means for receiving a user input and may comprise a personal computer, a cellular telephone or personal digital assistant equipped with computer network access, or a keypad (not shown) of an automated teller machine. For purposes of illustration only, the user input device will be referred to as a personal computer having a known web browser and a connection 24 to the Internet 18 to communicate information to the secure computer system 10 via the first input channel 26 or to the optional authentication server 16. An optional biometric sample collection device 28 such as a microphone, retinal scanner, or finger print scanner may be used with the user input device without departing from the spirit of the invention.

As discussed above, the system of the present invention may comprise authentication server 16 having a processor 30 and a plurality of memory storage units 32 and 34 for storing user account information. The authentication server 16 may communicate with the secure computer system 10 via two-way communications link 38 or via a secure Internet 18 connection. Further, authentication server 16 serves as a gateway or intermediary, as discussed hereinafter, to allow user access to secure computer system 10. Therefore, the authentication server 16 may comprise a third-party web-server adapted to execute a web-authentication application as disclosed in U.S. patent application Ser. No. 11/420,061 filed May 24, 2006, entitled “Graphical Image Authentication and Security System” the contents of which are incorporated fully herein.

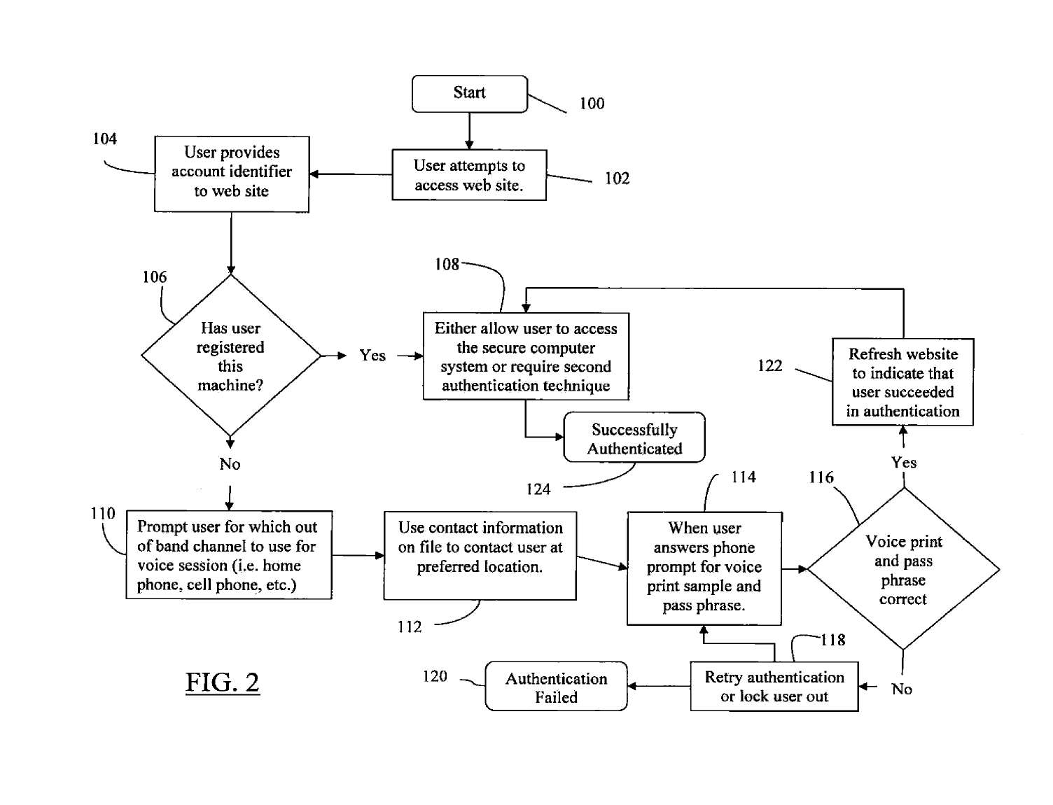

Turning now to FIG. 2, there is shown therein a flow chart diagram illustrating a high-level overview of the method of the present invention. At step 100 the process starts and the user attempts to access a web site associated with the secure computer system 10 at step 102. At step 104 the user is prompted to provide the account identifier to the secure computer system 10 via the web site. The user may then be asked if she has previously registered the user input device 12 she is using to access the website at Step 106. If the user input device 12 has been registered the process may proceed to step 108. However, if the user input device has not been previously registered to the secure computer system 10 the process will proceed to step 110 and the authentication method of the present invention begins. It will be appreciated that the web site may require users to continue to Step 110 each time they log into the website regardless of whether the computer has been previously registered. Additionally, it will be appreciated that the decision at step 106 may be based upon the identity of the user attempting to access the web site rather than the registration status of the computer. For example, user 1 may be registered to use the web site at their home computer and therefore not required to proceed through the biometric authentication process when logging in to the secure computer system. However, user 2 would be required to proceed through the biometric authentication process if she has not previously registered with the secure computer system using the same computer.

At step 110 the user is asked to select which user communication device she would like the authentication server to use for the biometric authentication session. The available user communication devices may be selected by the user during the initial registration process and may include the user's home phone, work phone, mobile device numbers or home computer equipped with a biometric sampler collection device 28 to collect biometric authentication elements. Additionally, the user may request to enter a new contact channel in the event they are traveling or their initial contact information has changed or is not applicable.

At step 112 the authentication server accesses the user's contact information to contact the user at the selected user communication device. In the present example the server may dial the user's cell phone number. When the user answers the server's call on the selected channel, the server may next prompt the user to state a pre-selected secret pass phrase. Alternatively, the server may request the user state their name, birthday, social security number or other identifying information. The authentication server next matches the unique voice print of the voice sample collected form the user's communication device as well as the content of the pass phrase spoken by the user to the stored voice print associated with the user account.

If the user's voice print does not match the stored voice print for the account the user may be required to retry authentication by repeating the pass phrase or by providing an alternative phrase (Step 118). In the event the user is unable to be authenticated by the authentication server the process moves to Step 120 and the user may be required to contact the service provider for assistance.

In the event the secret phrase and voice print match the secret phrase and voice print stored on the authentication server, the web site may be refreshed (Step 122) to indicate the user successfully authenticated to the server. The user is then either allowed to access the secure computer system or required to provide a second authentication technique (Step 108) before the user is successfully authenticated (Step 124).

As discussed with reference to FIG. 2, when the user accesses the secure computer system he or she may provide an account name to the authentication server 16 which in turn performs the authentication process shown in FIG. 2. The user selects a preferred communication channel and the authentication server 16 transmits a call signal to the user's selected communication device. For example, the server may dial the user's home phone via a land line 29. When the user answers the call the server will transmit a request that the user say her secret pass phrase. The user states her secret pass phrase which is transmitted to the authentication server 16. The authentication server 16 matches the secret pass phrase to the phrase selected by the user during initial registration and verifies the user's voice print to the voice print recorded during registration. After authentication is completed the call may be terminated. It will be appreciated that the server may transmit an additional message to the user thanking them for using the secure computer system or website or requesting the user enter a time specific code into the service provider's web site to complete the logon process. Additionally, messages from the server may include statements from an advertiser that has purchased ad space from the service provider. Alternatively, the user's secret phrase may include a slogan or advertising phrase used by the service provider or a third-party advertiser.

Referring now to FIGS. 1 and 2, the present invention also comprises a method to verify the identity of a computer system user. The method includes the secure computer system 10 adapted to store a user's account identifier established during the enrollment process. In accordance with the present method, a voice authentication element associated with the account identifier is stored at either the authentication server 16 (FIG. 1) or at the secure computer system 10. As discussed above, the voice authentication element may comprise an account specific voice print and an account specific pass phrase.

The voice print and user specific pass phrase may be collected during enrollment of the user by establishing a voice communication link with the user's communication device and prompting the user to speak a series of sounds. The user response is collected and recorded as a stored voice print at the memory storage device.

The user provides its account identifier using a first input channel adapted to receive the account identifier when he or she attempts to access the secure computer system from a first user input device such as a personal computer. A communications link is established between the computer system and a second input device comprising a user communication device. After establishing the communication link, the authentication server requests a voice input sample using a first output channel. The request prompts the user to provide a voice input sample by speaking into the biometric sample collection device 36 of the user communication device 14.

The voice input sample may comprise the voice print sample and a pass phrase sample. The voice input sample is transmitted from the user communication device 14 to the authentication processor 20 or 30. The user is authenticated when the voice print sample substantially matches the voice sample associated with the account identifier attempting to access the computer system and when the phrase sample substantially matches the account specific pass phrase. In accordance with the present method the account specific phrase may comprise a third-party advertisement. Further, requesting a voice print sample via the user communication device may comprise transmitting a third-party advertisement containing instructions for providing the voice input sample to the authentication server 20 or 30.

A second input channel may be established to receive the authentication element sample comprising the voice print sample and pass phrase sample from the user communication device 14. The processor 20 or 30 compares the voice print sample and pass phrase sample to the account specific voice print and account specific pass phrase. The use is authenticated to the computer system when the voice print sample substantially matches the voice print sample associated with the account identifier attempting to access the computer system and when the pass phrase sample substantially matches the account specific pass phrase.

As discussed above, the method of the present invention may further include transmitting a unique authentication parameter comprising an alphanumeric code to either an electronic mail address associated with the account identifier or the user communication device 14 upon receipt of the account identifier. The user receives the one-time randomly generated alphanumeric code and transmits the code to the authentication server using the user input device. The user is then authenticated to the secure computer system when the alphanumeric code sample received from the user's personal computer matches the code transmitting to the user's communication device or e-mail address.

Various modifications can be made in the design and operation of the present invention without departing from the spirit thereof. Thus, while the principal preferred construction and modes of operation of the invention have been explained in what is now considered to represent its best embodiments, which have been illustrated and described, it should be understood that the invention may be practiced otherwise than as specifically illustrated and described.

What is claimed is:

1. A method to verify an identity of a computer system user, comprising a computer system adapted to store an account identifier, the method comprising:
storing a voice authentication element associated with the account identifier, wherein the voice authentication element comprises an account specific voice print and an account specific pass phrase;
receiving the account identifier when an attempt to access the computer system from a first input device occurs;
establishing a communication link between the computer system and a second input device and requesting a voice input sample using the second input device;
receiving the voice input sample from the second input device, wherein the voice input sample communicates a voice print sample and a pass phrase sample;
authenticating the user when the voice print sample substantially matches the account specific voice print associated with the account identifier attempting to access the computer system and when the pass phrase sample substantially matches the account specific pass phrase.

2. The method of claim 1 wherein the account specific pass phrase comprises a third-party advertisement.

3. The method of claim 1 wherein requesting a voice input sample via the second input device comprises transmitting a third-party advertisement containing instructions for providing the voice input sample to the second input device.

4. The method of claim 1 further comprising transmitting a unique alphanumeric code to an electronic mail address associated with the account upon receipt of the account identifier, receiving an alphanumeric code sample from the first input device and authenticating the user to the computer system when the alphanumeric code sample matches the unique alphanumeric code transmitted to the electronic mail address.

5. The method of claim 1 wherein the account specific pass phrase comprises a user selected password, wherein the voice print sample received from the user comprises a password submission, and wherein the user is authenticated to the computer system when the password submission substantially matches the user selected password.

6. The method of claim 1 wherein the first input device comprises a personal computer having an Internet connection to access the computer system and wherein the second input device comprises a portable communication device.

7. The method of claim 6 wherein the portable communication device comprises a cellular telephone.

8. The method of claim 1 wherein the second input device is further adapted to receive a unique authentication parameter comprising a randomly generated password, the method comprising:
transmitting the unique authentication parameter to the second input device;
wherein authenticating the user further comprises receiving a communication from the first input device comprising the unique authentication parameter to verify an identity of the user.

9. The method of claim 1 wherein the account specific pass phrase comprises at least a single word.

10. A system for verifying the identity of a user to a computer system, the system comprising:
a memory storage device for storing an account identifier and an authentication element associated with the account identifier, wherein the authentication element comprises an account specific voice print and an account specific pass phrase;
a first input channel adapted to receive the account identifier from a first input device;
a first output channel adapted to transmit a request for an authentication element sample;
a second input channel adapted to receive the authentication element sample from a second user input device, wherein the authentication element sample comprises a voice print sample and a pass phrase sample; and
a processing unit for comparing the voice print sample and pass phrase sample of the authentication element sample to the account specific voice print and the account specific pass phrase of the authentication element associated with the account identifier.

11. The system of claim 10 wherein the authentication element further comprises a user selected textual password.

12. The system of claim 10 wherein the account specific pass phrase comprises at least a single word spoken by the user during an account enrollment.

13. The system of claim 12 wherein the account specific pass phrase comprises a user selected password, wherein the voice print sample received from the user comprises a password submission, and wherein the processing unit compares the password submission to the user selected password and permits user access to the computer system when the password submission and the user selected password are substantially similar.

14. The system of claim 12 wherein the account specific pass phrase comprises a sponsored phrase.

15. The system of claim 10 wherein the first output channel is further adapted to transmit a randomly selected verification code generated by the processing unit, the randomly selected verification code being associated with the user account identifier received from the first user input device for a single authentication session; wherein the first input channel is further adapted to receive the randomly selected verification code from the first user input device.

16. The system of claim 15 wherein the verification code comprises at least one alphanumeric character.

17. The system of claim 10 wherein the request for the authentication element sample comprises an advertisement.

18. The system of claim 10 wherein the computer system comprises a secure website.

19. A method for authenticating the identity of a website user, the method comprising:
providing a memory storage device for storing information including a stored voice print and an account identifier for each of a plurality of website users having access to a secure website, wherein the stored voice print comprises a user specific pass phrase;
receiving at least one account identifier transmitted from a computer system access device;
establishing a communication link with a voice communication device associated with the account identifier after receiving the account identifier;
collecting a voice print sample comprising a pass phrase sample from the voice communication device;
comparing the stored voice print to the voice print sample and comparing the pass phrase sample with the user specific pass phrase; and
authenticating the website user when both the stored voice print substantially matches the voice print sample and the pass phrase sample substantially matches the user specific pass phrase.

20. The method of claim 19 further comprising establishing a voice communication link with the website user; prompting the website user to speak a series of sounds; collecting a user response comprising the series of sounds; and recording the website user response as a stored voice print on the memory storage device.

21. The method of claim 19 further comprising transmission of a textual transmission to the voice communication device after establishing the communication link with the voice communication device.

22. The method of claim 21 wherein the textual transmission comprises a third-party advertisement.

23. The method of claim 21 wherein the textual transmission comprises a one-time pass code.

24. A system for authorizing a user to a secure website, the system comprising:
a memory unit for storing an account specific voice print comprising a unique pass phrase, an account identifier, and a voice communication device contact;
a means for receiving the account identifier from the user;
a means for establishing a communication link with a voice communication device using the voice communication device contact to receive a voice print sample comprising a pass phrase sample from the user; and
a processing means for comparing the sample voice print to the stored voice print associated with the user and for allowing access to the secure website when the stored voice print and the sample voice print are substantially identical.

25. The system of claim 24 wherein the voice communication device is further adapted to receive a unique authentication parameter and wherein the processing means is further adapted to assign the unique authentication parameter to the account identifier.

26. The system of claim 24 further comprising a means for transmitting an advertisement to the voice communication device.

27. A system for verifying the identity of a user to a secure website server, the system comprising:
an authentication server comprising memory storage device adapted to store a plurality of authentication elements related to a plurality of user accounts, wherein the authentication elements comprise an account identifier and a stored biometric authentication element, wherein each account identifier and stored biometric authentication element are unique to an individual user;
a first user input device adapted to query the secure website server for access to at least one of the user accounts and to transmit at least one account identifier to the secure website server;
a second user input device adapted to transmit a biometric authentication sample;
a communications module for establishing a communication channel between the website server, the second user input device, and the authentication server;
wherein the authentication server is adapted to verify the identity of the user and allow access to the secure website when the biometric authentication sample and the stored biometric authentication element associated with the account identifier are substantially similar.

28. The system of claim 27 wherein the first user input device comprises a personal computer.

29. The system of claim 27 wherein the first user input device and the second user input device comprise a single communications device.

30. The system of claim 5 wherein the authentication server comprises a third-party authentication gateway server.

31. The system of claim 27 wherein the second user input device comprises a cellular telephone.

32. The system of claim 27 wherein a third user input device adapted to transmit a second biometric authentication element to the authentication server.

33. The system of claim 27 wherein the first user input device and the third user input device are operatively connected.

34. The system of claim 33 wherein the first user input device comprises a personal computer and wherein the third user input device comprises one of a retinal scanner, fingerprint scanner, or microphone.
